(19) United States
(12) Patent Application Publication
(10) Pub. No.: US 2011/0115614 A1
(43) Pub. Date: May 19, 2011

(54) DIRECTION LIGHT AND ILLUMINATION DEVICE FOR BICYCLE

(76) Inventors: Chien-Chang Huang, Taipei (TW); Chang-Bin Huang, Taipei (TW)

(21) Appl. No.: 12/618,769

(22) Filed: Nov. 15, 2009

(51) Int. Cl. B62J 6/00

(52) U.S. Cl. 340/432

(57) ABSTRACT

A direction light and illumination device for bicycle includes a direction light unit arranged to a bicycle handling and a rear portion of a bicycle frame. The direction light unit includes a front support, a rear support, a front left light, a front right light, a rear left light, a rear right light, and a controller. The front left light and the front right light are arranged to two ends of the front support. The rear left light and the rear right light are arranged to two ends of the rear support. The controller is electrically connected to all direction lights so as to light up both two right or left lights for indicating a turning direction for safety.

### FIELD OF THE PRESENT INVENTION

The present invention relates to alerting light device, and particular to a direction light, illumination device, and a back mirror device for a bicycle.

### DESCRIPTION OF THE PRIOR ART

More and more people enjoy riding bicycle as a recreation for relaxing and exercising. Riding bicycle is also an activity of low carbon emission to protect the earth.

With the population of the riding, the safety of the activity has been required by the consumers. Therefore, the safety of steering, illumination, and back-sighting become key concerns for the user as well as relate government departments.

Prior bicycle uses reflector or flash light as a safety device while riding in environments lack of light. However, without direction lights and back mirrors for alerting a changing direction and back-sighting during riding, accidents are usually happened during turnings on regular roads used by pedestrians or common vehicles.

### SUMMARY OF THE PRESENT INVENTION

Accordingly, the primary objective of the present invention is to provide a direction light and illumination device for bicycle. A direction light unit of the present invention is arranged to a bicycle handling and a rear portion of a bicycle frame. The direction light unit includes a front support, a rear support, a front left light, a front right light, a rear left light, a rear right light, and a controller. The front left light and the front right light are arranged to two ends of the front support so that the direction light and illumination device for bicycle will have a wider angle of visibility and illumination. The rear left light and the rear right light are arranged to two ends of the rear support. The controller is electrically connected to all direction lights so as to light up both two right or left lights for indicating a changing direction to surrounding pedestrians and vehicles.

Preferably, the direction light and illumination device for bicycle further includes a back mirror unit. Rider will have an immediately back-sighting for extra safety.

Moreover, an illumination unit is included by the present invention for front illumination.

The direction light and illumination device for bicycle according to the present invention further has flexible front and rear supports.

The left shaft and the right shaft are oppositely fixed to two ends of the handling. The shafts can be used for temporary rest during riding.

### BRIEF DESCRIPTION OF THE DRAWINGS

FIG. 1 is a schematic view showing the first embodiment of a direction light and illumination device for bicycle of the present invention.

FIG. 2 is an enlarged view showing a front left light and a front right light on a handling of a bicycle in FIG. 1.

FIG. 3 is an enlarged view showing a rear left light and a rear right light on a rear support in FIG. 1.

FIG. 4 is a schematic view showing the second embodiment of the present invention.

FIG. 5 is an enlarged view showing a front left light and a front right light on a handling of a bicycle in FIG. 4.

FIG. 6 is a schematic view showing the third embodiment of the present invention.

FIG. 7 is an enlarged view showing a front left light, a front right light, a back mirror unit, and an illumination unit on a handling of a bicycle in FIG. 5.

FIG. 8 is a schematic view showing the fourth embodiment of the present invention.

FIG. 9 is an enlarged view showing a front left light, a front right light, a back mirror unit, and a flexible front support on a handling of a bicycle in FIG. 8.

FIG. 10 is an enlarged view showing a flexible rear support of the present invention.

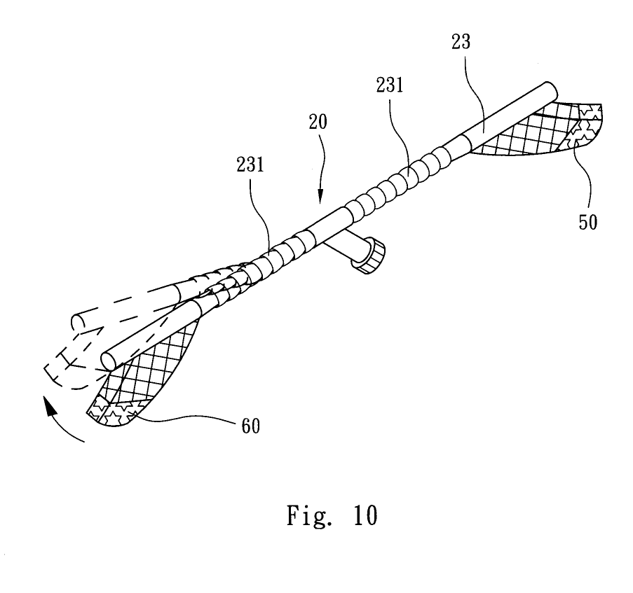

FIG. 11 is a schematic view showing another embodiment of a horns-like front support of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

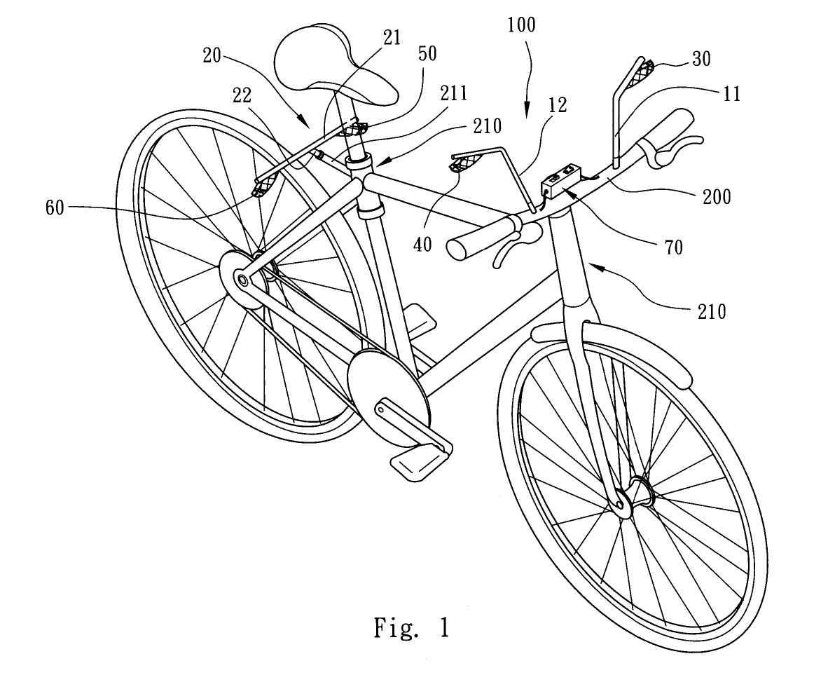

Referring to FIG. 1, a first embodiment of a direction light and illumination device for bicycle according to the present invention is illustrated. A direction light unit 100 is arranged to a bicycle handling 200 and a rear portion of a bicycle frame 210.

The direction unit 100 includes a rear support 20, a front left light 30, a front right light 40, a rear left light 50, a rear right light 60, and a controller 70. The rear left light 50 and the rear right light 60 are arranged to two ends of the rear support 20. The controller 70 is electrically connected to the front left light 30, front right light 40, rear left light 50, and rear right light 60 so as to light up between right or left lights for indicating a changing direction or to light up all the lights for alerting in a poor sight circumstance.

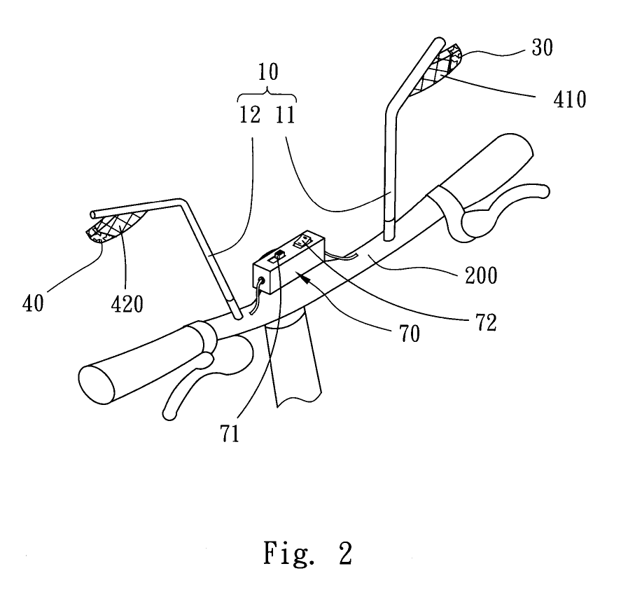

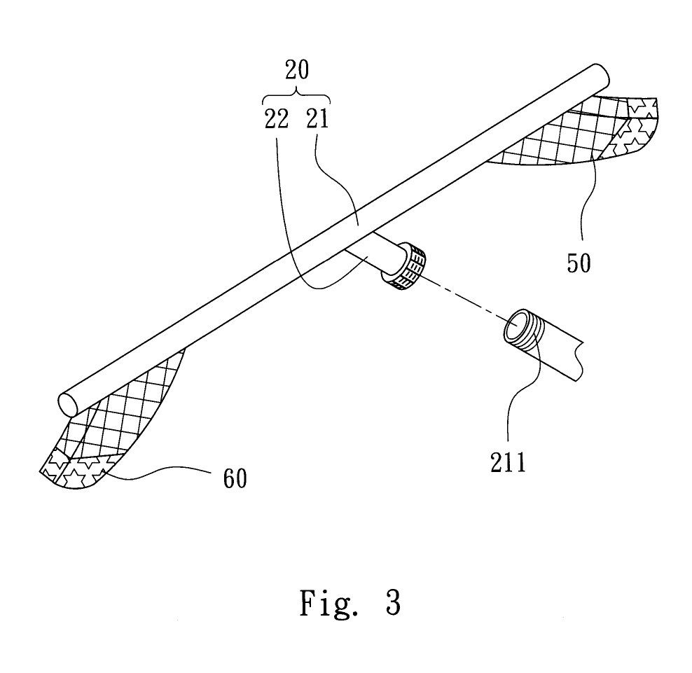

Referring to FIGS. 1 to 3, the direction light and illumination device for bicycle preferably includes a front support 10. The front left light 30 and the front right light 40 are arranged to two ends of the front support 10 so that the direction light and illumination device for bicycle will have a wider angle of visibility.

The front support 10 further has a left shaft 11 and a right shaft 12. The front left light 30 is arranged to an end of the left shaft 11, and the front right light 40 is arranged to an end of the right shaft 12. The rear left light 50 and the rear right light 60 are arranged to the two ends of the rear support 20. The controller 70 is arranged to the handling 200. The controller 70 is electrically connected to the front left light 30, front right light 40, rear left light 50, and rear right light 60. The controller can be operated to light up both the front left light 30 and the rear left light 50 or both the front right light 40 and the rear right light 60 so as to alert a changing direction for the followers in case of preventing a traffic accident.

The bicycle frame 210 further includes a connecting portion 211. The rear support 20 has a main support portion 21 and a linking portion 22. The rear support 20 in the embodiment has an approximate shape as “T”. The rear left light 50 and the rear right light 60 are fixed to two ends of the main support portion 21, and the linking portion 22 is separably connected to the connecting portion 211 of the bicycle frame 210. Therefore, it can be installed easily and can be removed from being theft. The rear lights are portable and with independent power supply (battery) so that it could be removed as a flash light, illumination for camping, or reading.

The controller 70 has a power switch 71 and a light switch 72. The power switch 71 serves to turn on the power of the direction light unit 100. The light switch 72 can be stirred towards left or right to light up the left or the right direction lights respectively. The power switch 71 can be switched to light up all the direction lights 30, 40, 50, 60 for alerting.

Moreover, the front left light 30, front right light 40, rear left light 50, and the rear right light 60 can be respectively divided into two different lighting zone with different color (such as yellow and red) for different alerting effect.

The direction light and illumination device for bicycle further has an illumination unit 400. The illumination unit 400 has two lamps 410 and 420, and at least one of the lamps is arranged to the front support 10. Preferably, the lamps 410 and 420 are embedded to the front left light 30 and the front right light 40 respectively and are capable of illuminating ahead.

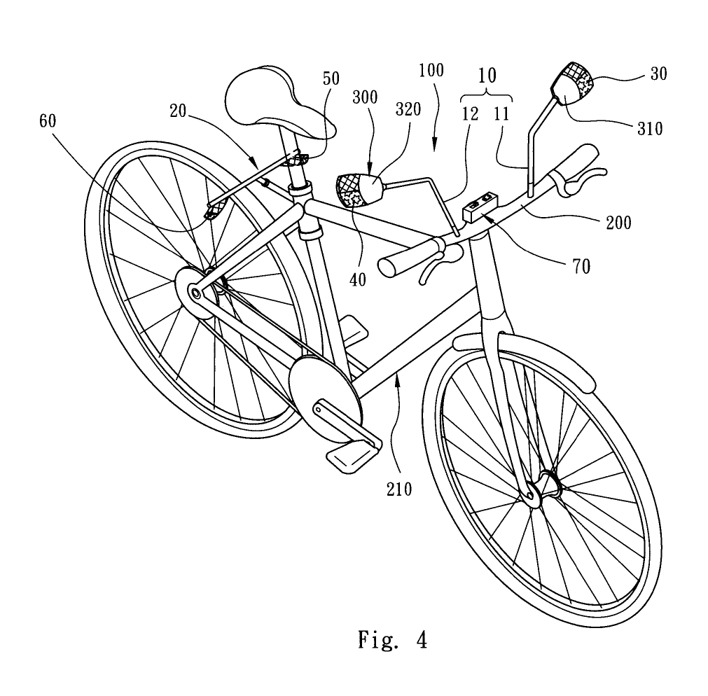

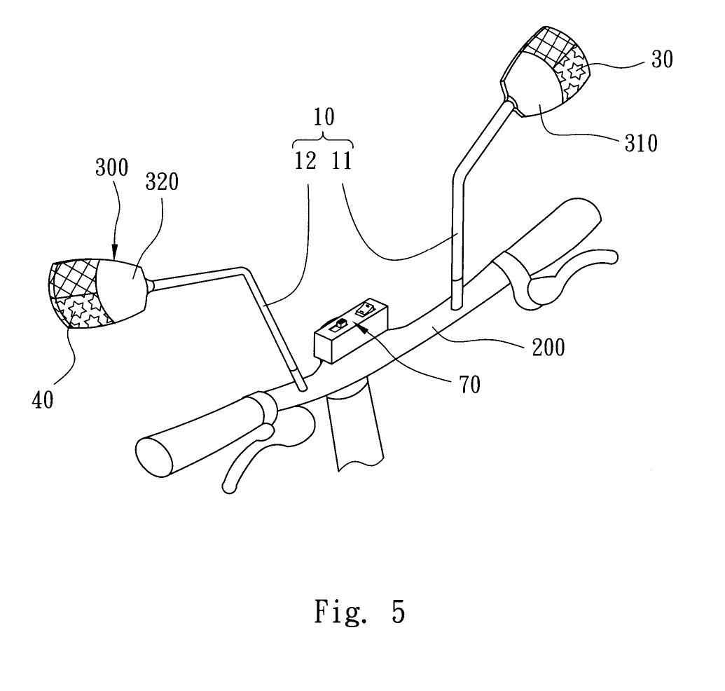

Referring to FIGS. 4 and 5, a second embodiment of the direction light and illumination device for bicycle includes a direction light unit 100 and a back mirror unit 300. The direction light unit 100 is arranged above the handling 200 and a rear of the bicycle frame 210.

The direction light unit 100 includes a front support 10, a rear support 20, a front left light 30, a front right light 40, a rear left light 50, a rear right light 60, and a controller 70 as the first embodiment of the present invention.

The back mirror unit 300 includes a left back mirror 310 and a right back mirror 320. The front support 10 includes a left shaft 11 and a right shaft 12. The left back mirror 310 and the front left light 30 are arranged to the left shaft 11 and the right back mirror 320 and the front right light 40 are arranged to the right shaft 12. Preferably, the front left light 30 and the front right light 40 are embedded to the left back mirror 310 and the right back mirror 320 respectively.

Besides the direction light unit 100, the rider can see coming vehicles behind through the back mirror unit 300 for further safety of riding. The bicycle will have all basic functions as motorcycles and cars.

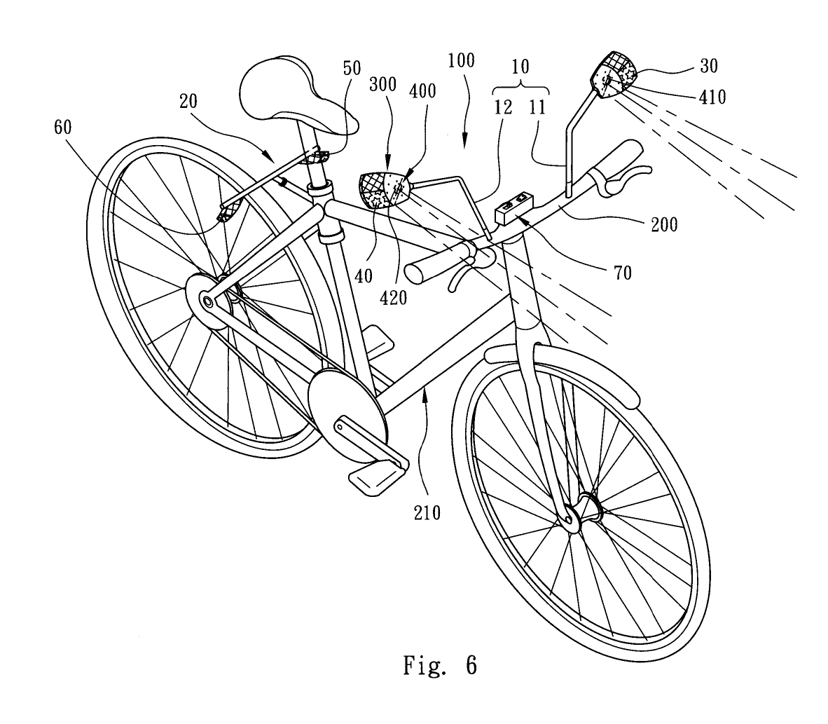

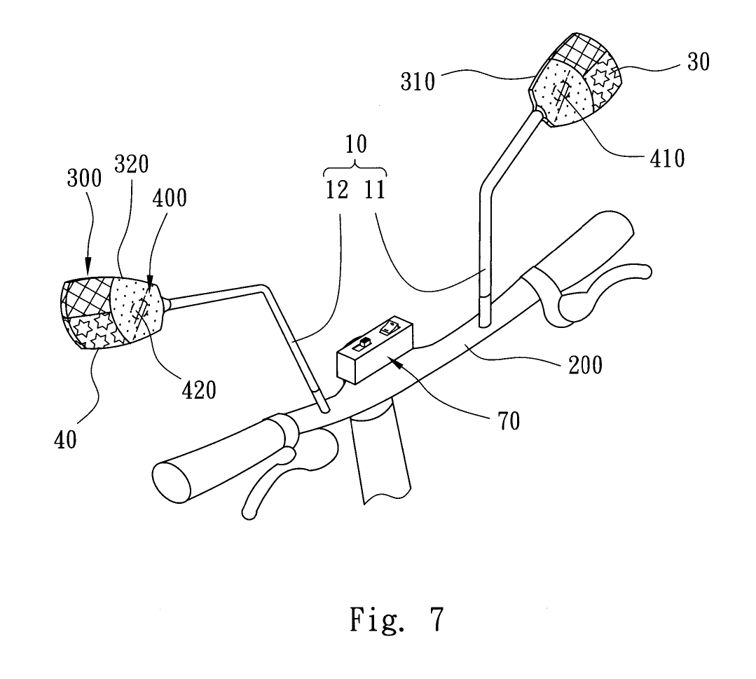

Referring to FIGS. 6 and 7, a third embodiment of the present invention including a direction light unit 100, a back mirror unit 300, and an illuminating unit 400 are illustrated. The direction light unit 100 is arranged above the handling 200 and the rear of the bicycle frame 210.

In the embodiment, the controller 70 is powered by battery. The direction light unit 100 using LEDs is power-saving.

The direction light unit 100 includes a front support 10, a rear support 20, a front left light 30, a front right light 40, a rear left light 50, a rear right light 60, and a controller 70 as the first embodiment of the present invention.

The back mirror 300 includes a left back mirror 310 and a right back mirror 320. The front support 10 includes a left shaft 11 and a right shaft 12. The left back mirror 310 and the front left light 30 are arranged to the left shaft 11 and the right back mirror 320 and the front right light 40 are arranged to the right shaft 12. The front left light 30 and the front right light 40 are embedded to the left back mirror 310 and the right back mirror 320 respectively.

The illuminating unit 400 has two lamps 410 and 420. The lamps 410 and 420 are embedded to the left back mirror 310 and the right back mirror 320 respectively and capable of illuminating ahead.

Besides the direction light unit 100, the back mirror unit 300 and the illumination unit 400 of the present invention will improve a safety of the riding especially in an environment lack of lights.

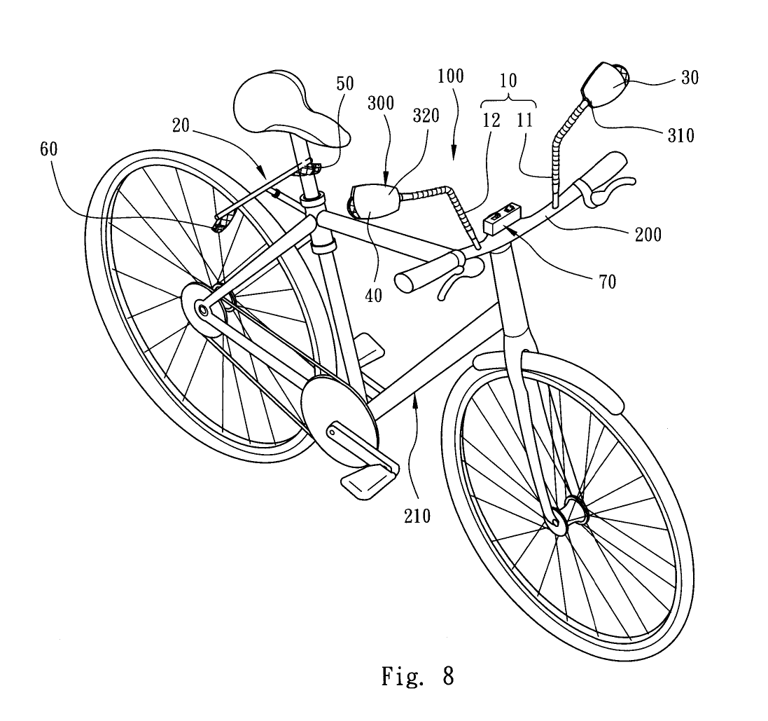

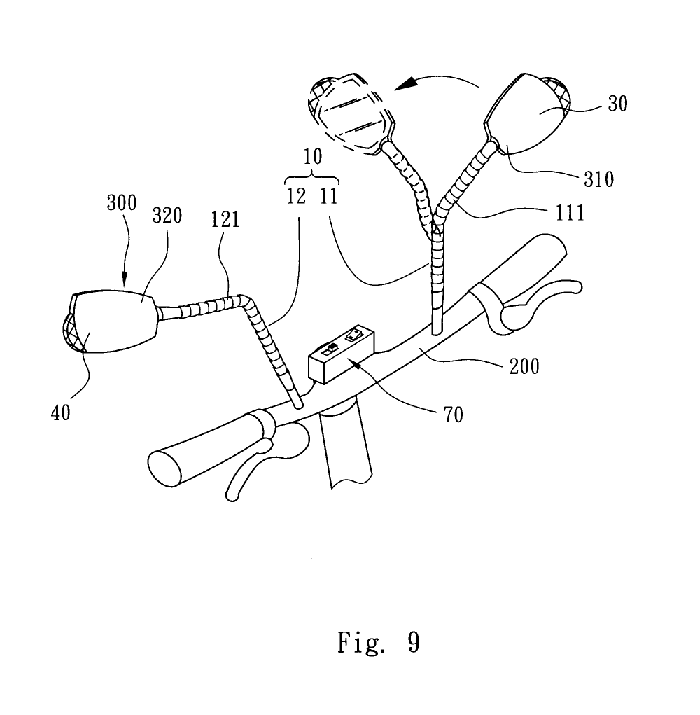

Referring to FIGS. 8 and 9, a fourth embodiment of the present invention including a direction light unit 100 and a back mirror unit 300 are illustrated. The direction light unit 100 is arranged above the handling 200 and the rear of the bicycle frame 210. The direction light unit 100 includes a front support 10, a rear support 20, a front left light 30, a front right light 40, a rear left light 50, a rear right light 60, and a controller 70 as the first embodiment of the present invention.

The back mirror 300 includes a left back mirror 310 and a right back mirror 320. The front support 10 includes a left shaft 11 and a right shaft 12. The left back mirror 310 and the front left light 30 are arranged to the left shaft 11 and the right back mirror 320 and the front right light 40 are arranged to the right shaft 12. The front left light 30 and the front right light 40 are embedded to outer edges of the left back mirror 310 and the right back mirror 320 respectively.

The left shaft 11 and the right shaft 12 of the front support 10 are flexible by a plurality of universal units 111 and 112 thereof respectively. The universal units are serial linked so as to form a flexible rod.

Besides the direction light unit and the back mirror unit 300, the flexible left shaft 11 and the right shaft 12 capable of adjusting angles and positions of the back mirrors as well as the direction lights can be adjusted for the needs of the users.

Referring to FIG. 9, the back mirror unit 300 and the front left light 30 or the front right light 40 are rotated to another angle.

Moreover, a main support portion 23 of the rear support 20 is flexible by a plurality of universal units 231. The universal units are serial linked so as to form a flexible rod. Angles of the rear left light 50 and the rear right light 60 can be thus adjusted.

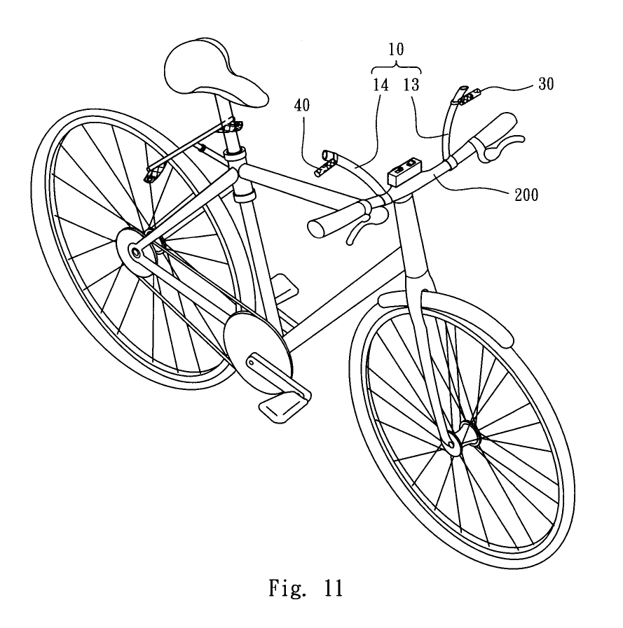

Referring to FIG. 11, a left shaft 13 and a right shaft 14 can be formed as horns for handling. The left shaft 13 and the right shaft 14 are oppositely fixed to two ends of the handling 200 for fixed by the direction lights. The shafts can be used for temporary rest during riding.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A direction light and illumination device for bicycle comprising:
a direction light unit arranged above a handling of a bicycle and a rear of a bicycle frame having a rear support, a front left light, a front right light, a rear left light, a rear right light, and a controller; the rear left light and the rear right light being fixed to two ends of the rear support respectively; the controller being electrically connected to the front left light, front right light, rear left light, and the rear right light so as to light up both right or left lights.

2. The direction light and illumination device for bicycle as claimed in claim 1 further comprising a front support; the front support including a left shaft and a right shaft; the front left light being arranged to the left shaft, and the front right light being arranged to the right shaft.

3. The direction light and illumination device for bicycle as claimed in claim 2 further comprising a illumination unit; the illumination unit including at least one lamp; the at least one lamp lighting ahead being arranged to at least one of the left shaft and the right shaft.

4. The direction light and illumination device for bicycle as claimed in claim 2 further comprising a back mirror unit; the back mirror unit including a left back mirror and a right back mirror; the left back mirror being arranged to the left shaft and the right back mirror being arranged to the right shaft so that the front left light is arranged to the left back mirror and the front right light is arranged to the right back mirror.

5. The direction light and illumination device for bicycle as claimed in claim 4 further comprising the back mirror unit and an illumination unit; the back mirror unit including a left back mirror and a right back mirror; the illumination unit including at least a lamp; the at least one lamp being embedded to at least one of the left back mirror and the right back mirror.

6. The direction light and illumination device for bicycle as claimed in claim 5, wherein the at least one lamp of the illumination unit is embedded to at least one of the front left light and the front right light.

7. The direction light and illumination device for bicycle as claimed in claim 2, wherein the left shaft and the right shaft of the front support are flexible; the left shaft and the right shaft are formed by a plurality of universal units respectively; the plurality of the universal units are serial linked so as to form a flexible shaft respectively.

8. The direction light and illumination device for bicycle as claimed in claim 1, wherein the bicycle frame has a connecting portion; the rear support has a main support portion and a linking portion; the rear left light and the rear right light are arranged to two ends of the main support portion; the linking portion is separably connected to the connecting portion of the bicycle frame.

9. The direction light and illumination device for bicycle as claimed in claim 5, wherein the main support portion of the rear support is flexible; the main support portion is formed by a plurality of universal units; the plurality of the universal units are serial linked so as to form the flexible main support portion.

10. The direction light and illumination device for bicycle as claimed in claim 1, wherein the left shaft and the right shaft of the front support are arranged to two ends of the handling of the bicycle for additional handling.

11. The direction light and illumination device for bicycle as claimed in claim 4, wherein the front left light is embedded to the left back mirror and the front right light is embedded to the right back mirror.

12. The direction light and illumination device for bicycle as claimed in claim 11, wherein the front right light and the front right light are embedded to outer edges of the left back mirror and the right back mirror respectively.

13. The direction light and illumination device for bicycle as claimed in claim 5, wherein the at least one lamp is arranged to at least one of the front right light and the front right light.

14. The direction light and illumination device for bicycle as claimed in claim 1, wherein the direction lights are respectively divided into two lighting zone with different color.
